(19) United States
(12) Patent Application Publication
(10) Pub. No.: US 2005/0228790 A1
(43) Pub. Date: Oct. 13, 2005

(54) Coherent categorization scheme

(76) Inventors: Christopher Ronnewinkel, Heidelberg (DE); Florian Weigmann, Karlsruhe (DE); Michael Kuehn, Palo Alto, CA (US); Lewis W.B. Charnock, Harleysville, PA (US); Janaki Kumar, Palo Alto, CA (US)

Correspondence Address: FISH & RICHARDSON, P.C., PO BOX 1022, MINNEAPOLIS, MN, 55440-1022, US

(21) Appl. No.: 10/822,363

(22) Filed: Apr. 12, 2004

(51) Int. Cl. G06F 17/30

(52) U.S. Cl. 707/6

(57) ABSTRACT

Programs and methods involve structuring categories coherently such that a single categorization scheme may be used to perform multiple business process steps. A method of responding to a received message includes analyzing content of a received message to select which of a plurality of predefined categories relates to the received message. Each predefined category has response information linked to it. If a first of a number of predefined computer-executable response modules is executed, then the first module executes using at least a first part of the response information linked to the selected category. If a second of the number of predefined computer-executable response modules is executed, then the second module executes using at least a second part of the response information linked to the selected category.

### TECHNICAL FIELD

This invention relates to categorizing information to perform business processes.

### BACKGROUND

Enterprise systems encompass systems that perform multiple business processes. Performing a business process (or a step in a business process) involves executing some predetermined actions. Some enterprise systems perform business processes in response to an input, such as an email from a customer. In performing such business processes, inputs may be categorized according to their content and/or characteristics. Inputs may be categorized for the purpose of retrieving stored information that is relevant to performing a business process in the presence of that input. One example of an enterprise system that can use categorization is a Customer Relationship Management (CRM) system. Within a CRM system, one example of a system that performs multiple business processes is an e-mail response management system (ERMS). An ERMS is a system for managing a high volume of in-bound emails, and which partially or wholly automates routing and responding to emails.

As it applies to ERMS, categorization can be used to respond to an inbound email request from a customer. For example, categorization may involve determining to which category the customer's request relates. In one example, the customer request may be evaluated to determine if it matches a company locations category, a company operations category, or a company products category. If the customer request relates to the company products category, then a further determination may be made as to whether the customer request relates, for example, to a product pricing category, a performance specifications category, or an assembly instructions category. The result of the categorization is the selection of at least one category that relates to the customer's request.

Accordingly, the ERMS system can use the selected category to automate the performance of various business process steps. For example, the ERMS system can use the selected category to automatically suggest responses that the agent could use in the reply. If, in this example, the customer requests information about how to assemble a purchased product, and if a document containing product assembly instructions is linked to the selected category, then the ERMS can automatically suggest that the agent attach that document to the reply email.

When categorization occurs in a business process, the categorization may be performed either manually or automatically using a computer system. In an enterprise computing system, a number of software modules may each, when executed, perform a different business process or business process step. As such, each different business process software module may categorize inputs using different categories and different categorization schemes.

In systems such as ERMS, categorization schemes can relate a business process to business objects (stored information) that are relevant to performing that business process in the presence of a particular input (e.g. inbound customer email). For example, if a customer sends to a customer service center an email requesting directions to a store, a categorization scheme may be used in one business process step to identify a document containing driving directions that may be attached to a reply email. Other categorization schemes may be used in subsequent business process steps to prepare a reply email.

Categorization schemes may be flat or hierarchical. In a hierarchically structured categorization scheme, an input that is to be categorized may be evaluated against increasingly specific criteria as the hierarchy is navigated from its peak to successively lower categories. Each category may be linked to one or more business objects. The business objects associated with the selected category represent information that may be used to perform a particular business process.

One exemplary application for categorization schemes is an Interaction Center (IC), which encompasses call centers, customer support centers, and the like.

### SUMMARY

This document describes various computing software programs and methods that enable a system, such as an enterprise computing system, to obtain higher levels of integration and performance by improving coordination among business process steps. These programs and methods involve structuring categories coherently such that a single categorization scheme may be used to perform multiple business process steps. For example, in an ERMS business process, a coherent categorization scheme may be used to choose a category that is relevant to the contents of an incoming email message. Linked to the selected category are business objects, such as response templates and documents. In an ERMS with coherent categorization, the business process steps may include: (1) providing a standard email response template and (2) selecting documents to attach to a reply email to the customer. Both of these business process steps can use the business objects associated with the selected category. The business objects may be automatically suggested to a user of the ERMS, thereby reducing the time required to prepare the reply e-mail. Accordingly, coherent categorization can provide for efficient processing of a high volume of inbound emails in an ERMS.

In one aspect, a method of responding to a received message includes analyzing content of a received message to select which of a plurality of predefined categories relates to the received message. Each predefined category has response information linked to it. If a first of a number of predefined computer-executable response modules is executed, then the first module executes using at least a first part of the response information linked to the selected category. If a second of the number of predefined computer-executable response modules is executed, then the second module executes using at least a second part of the response information linked to the selected category.

In another aspect, a computer program product is tangibly embodied in an information carrier. The computer program product contains instructions that, when executed, cause a processor to perform operations that correspond to the method described above.

In another aspect, a method of performing multiple steps in an Interaction Center (IC) business process includes receiving an email. The content of the email relates to one of a number of predetermined categories in a categorization scheme. Business objects are linked to each predetermined category. The method also includes selecting a category from among the number of predetermined categories, and receiving user input that identifies which of a number of response procedure modules to execute in response to the received email. If an email editor module is executed, the method includes using a response template selected from among the business objects linked to the selected category. If an ERMS module is executed, the method includes suggesting at least one business object linked to the selected category. The suggested business object includes at least one of a quick solution document and an expert selected from among the business objects linked to the selected category.

The foregoing methods and computer program products may also involve various modifications. For example, executing one of the first and second modules may involve displaying suggested response message content on a display device, the suggested content being included in the linked response information. The suggested content may include at least one document or at least one response template. The method may further involve receiving user commands to send a response message with the suggested content. In such case, a message routing instruction may route the received electronic message to a user's incoming electronic message account, the message routing instruction being included in the linked response information.

In other examples, the execution may involve executing a message routing instruction that routes the received electronic message to a user's incoming electronic message account, the message routing instruction being included in the linked response information. The user's incoming electronic message account may be that of an expert.

In some examples, the first module may be one that produces a response message, and the second module is one that executes a procedure other than producing a response message. The first part of the response information linked to the selected category may be an auto-response, or it may involve suggested content. The other procedure may be service related, which, in some cases, may involve scheduling a service order.

In some examples, the first and second parts of the linked response information may be different, or the received message may be an e-mail.

The use of coherent categorization according to the foregoing implementations can yield several advantages in an ERMS. For example, auto-suggested business objects can be filtered so that only linked business objects of the type most relevant to the business process being performed are displayed to an agent. As such, a categorization scheme can be configured to reduce the time and effort the agent must spend performing the business process. This allows the agent to realize productivity and efficiency improvements. If the categorization is also coherent, a single categorization can serve more than one business process step. By reducing the number of categorizations required to perform a number of business process steps, a coherently categorized system further reduces or eliminates unnecessary time and effort the agent must spend to perform multiple business process steps. As such, coherently categorized systems can yield further efficiency and productivity gains over systems that are not coherently categorized.

The details of one or more embodiments of the invention are set forth in the accompanying drawings and the description below. Other features, objects, and advantages of the invention will be apparent from the description and drawings, and from the claims.

DESCRIPTION OF DRAWINGS

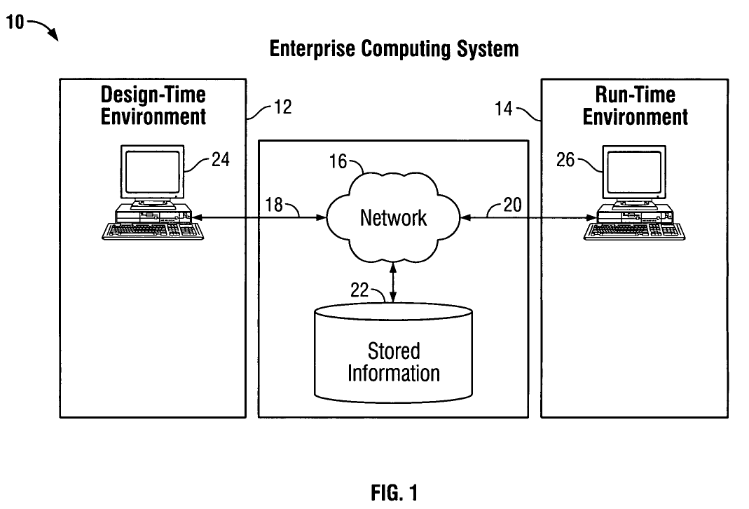

FIG. 1 is an enterprise computing system.

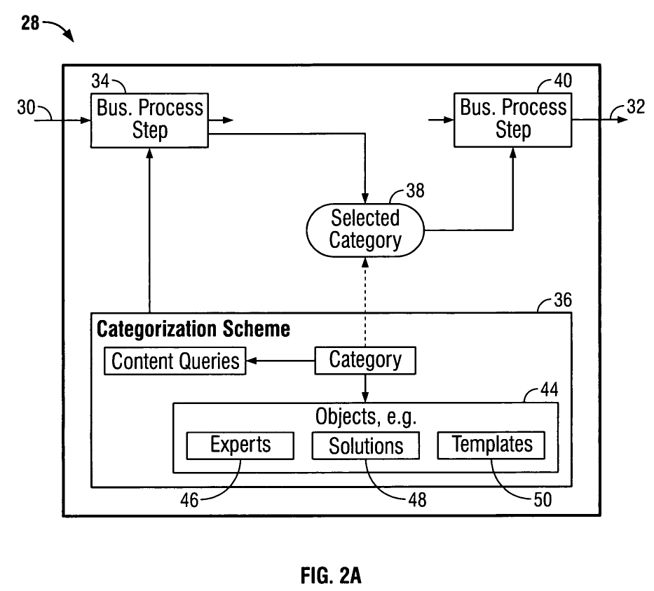

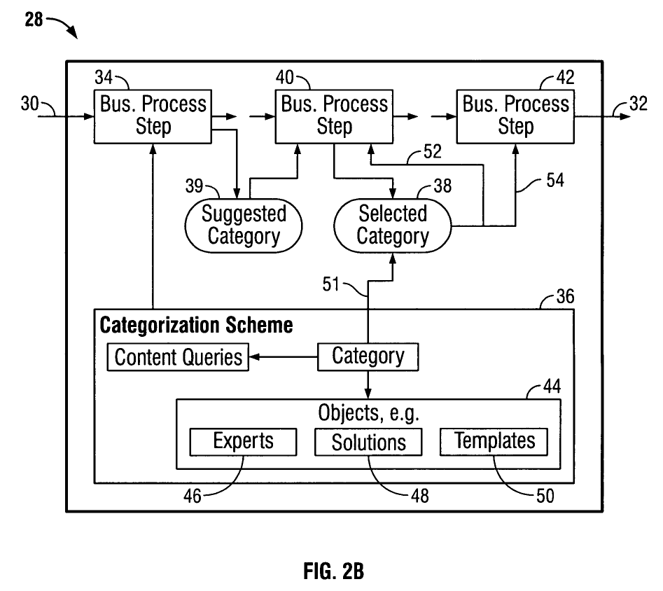

FIGS. 2A-2B are run-time flow diagrams of a business application using a coherent categorization scheme.

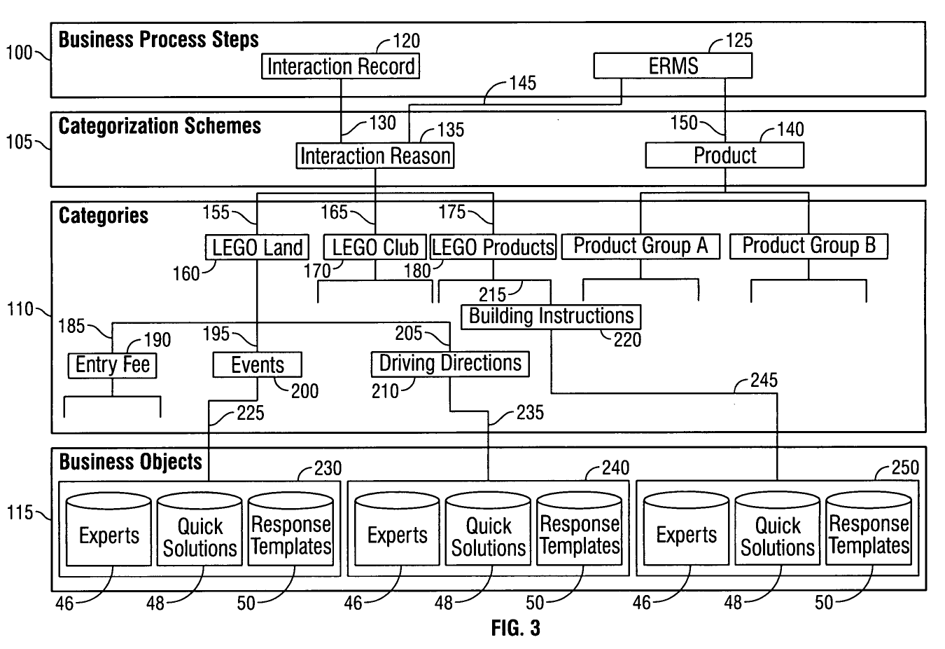

FIG. 3 is a categorization scheme.

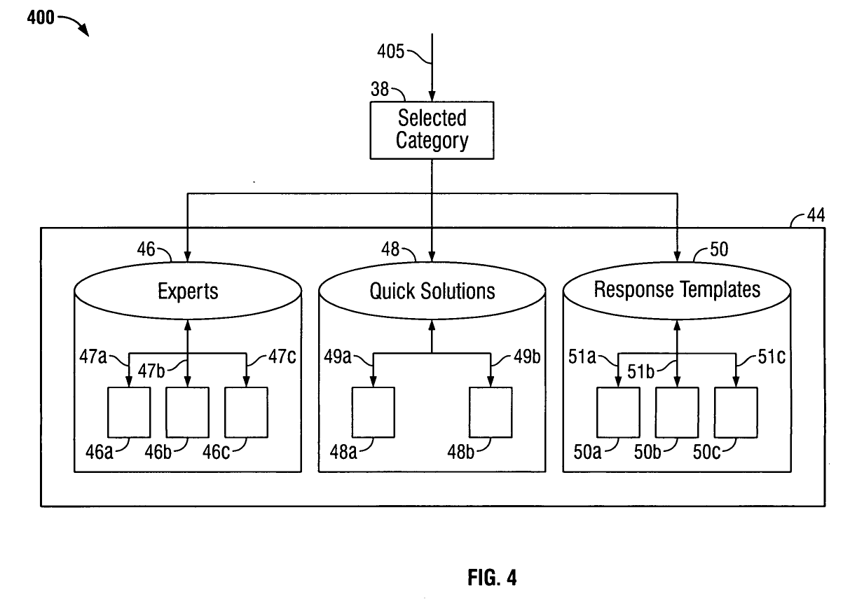

FIG. 4 is a portion of the categorization scheme of FIG. 3 with additional detail.

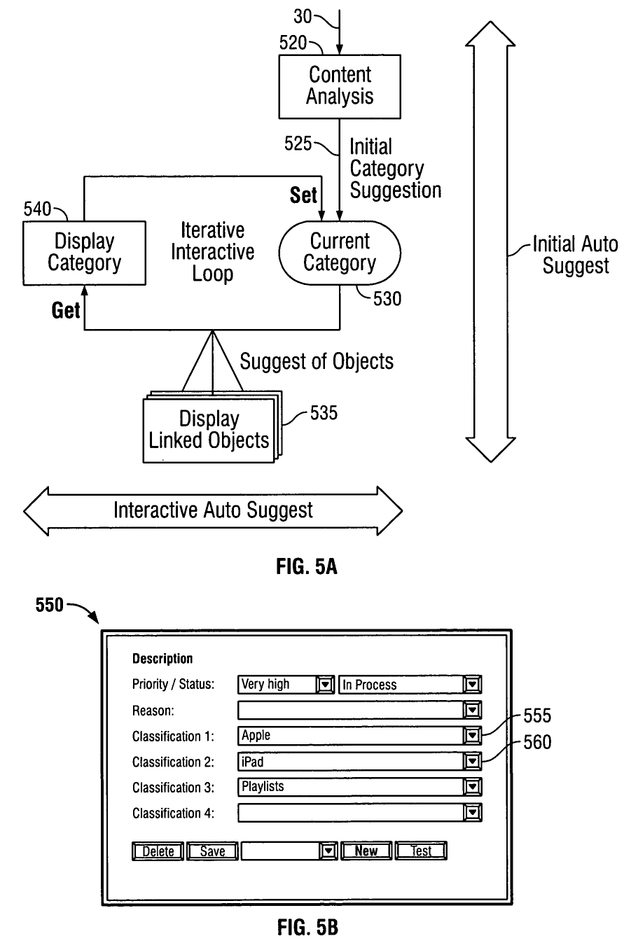

FIG. 5A is a conceptual diagram of the process steps performed when manually selecting a category in a categorization scheme in accordance with FIG. 2B.

FIG. 5B is a user interface for manually selecting categories using the process of FIG. 5A.

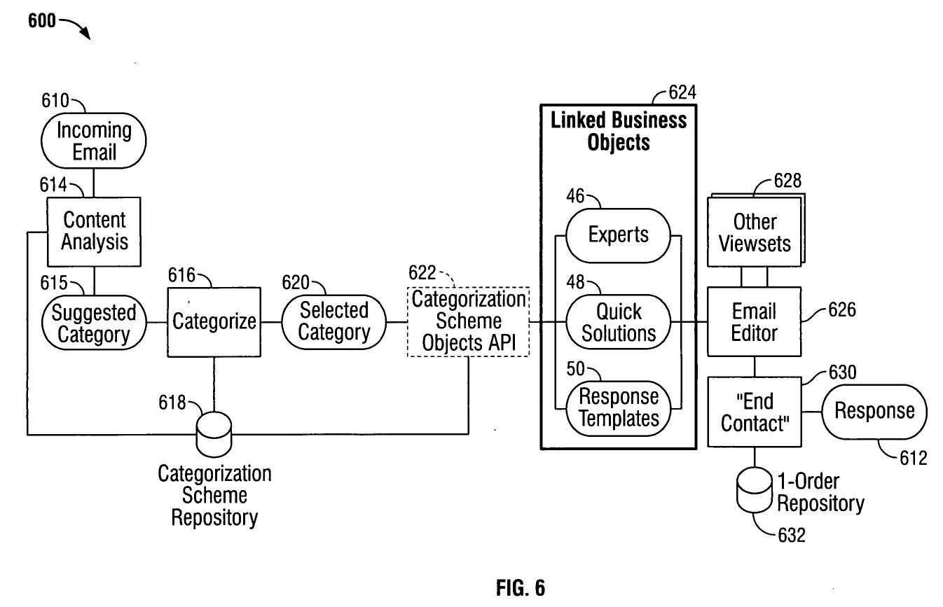

FIG. 6 is a block diagram of an ERMS business process using coherent categorization schemes of FIG. 3.

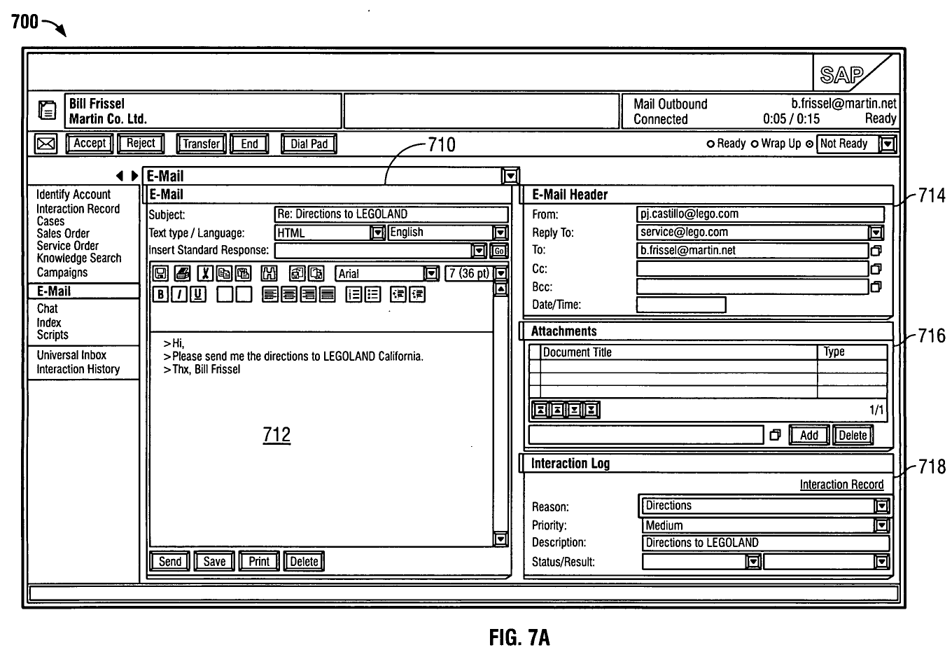

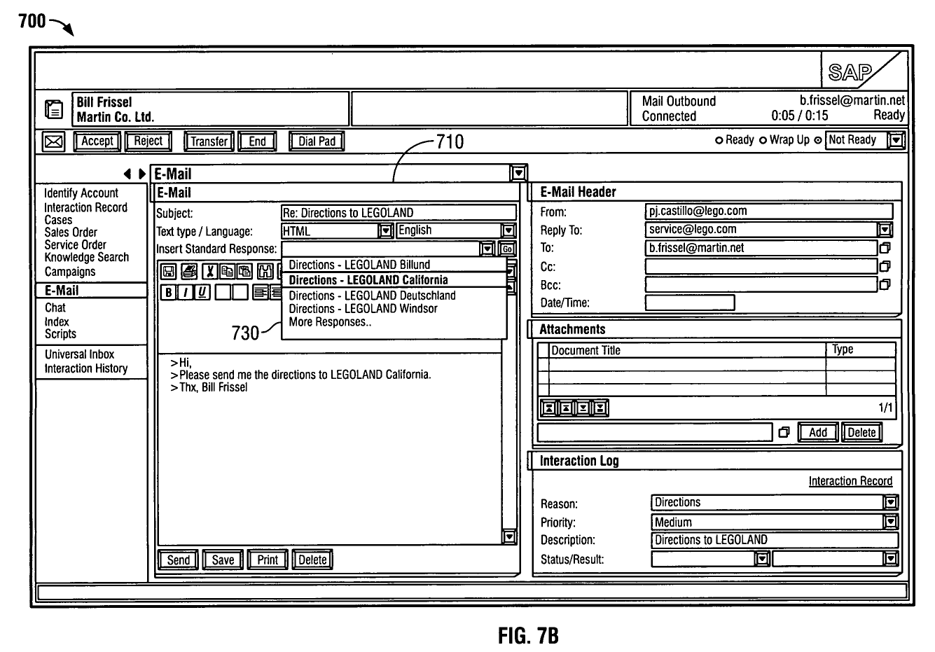

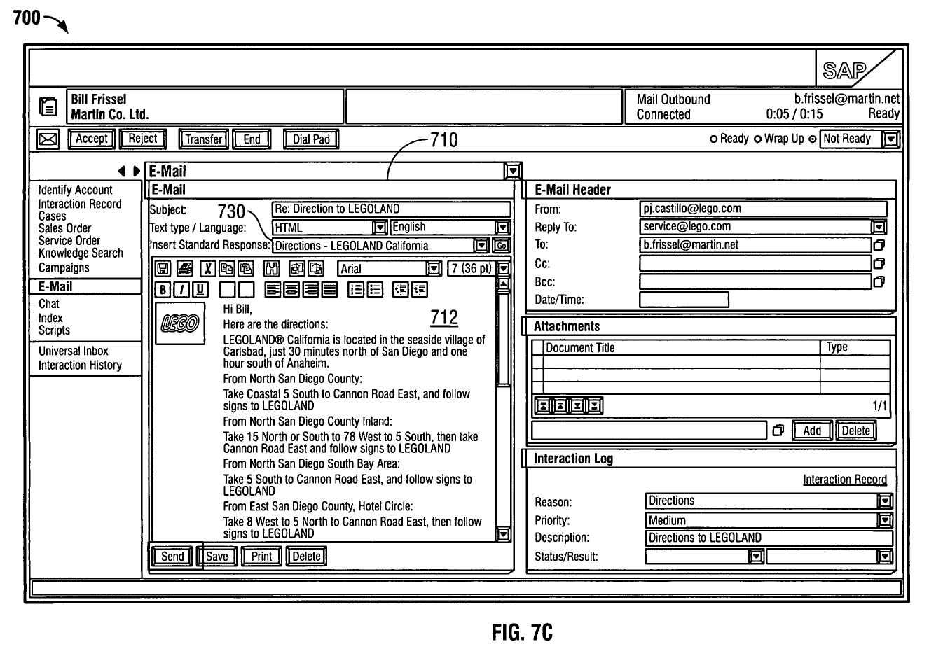

FIGS. 7-9 are screen shots of an exemplary run-time graphical user interface (GUI) for the ERMS of FIG. 6.

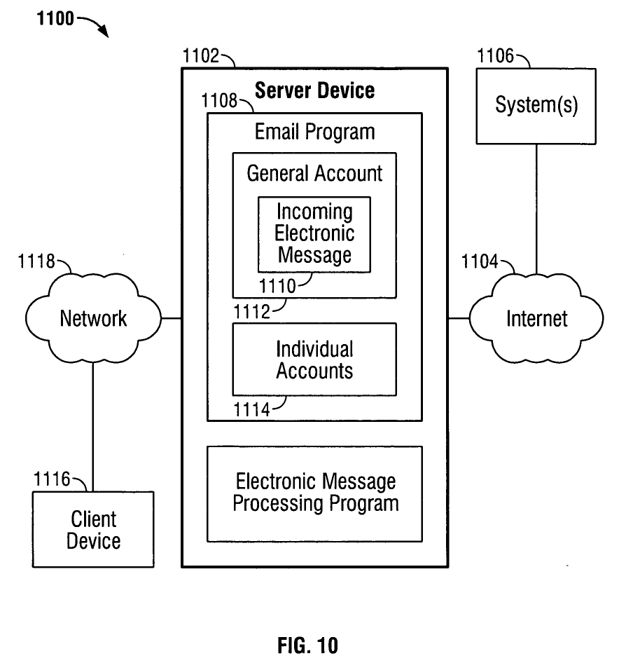

FIG. 10 is an ERMS computing system that provides for routing incoming messages to experts.

Like reference symbols in the various drawings indicate like elements.

### DETAILED DESCRIPTION

Coherent categorization may be used to improve productivity achieved by computing software that performs multiple steps in a business process (or in multiple business processes). When a business process receives an input that is to be processed using a series of business process steps, how the input is categorized determines the action that each of the business process steps will take. Process efficiencies can be gained, thereby improving productivity, if the business processes and categorization schemes are structured so that a single categorization result can be used by more than one of the business process steps. Accordingly, coherent categorization is achieved when multiple business process steps can directly use the result of a single categorization.

One example of enterprise computing software that can benefit from coherent categorization is an email response management system (ERMS). In FIG. 1, an enterprise computing system 10 may be used to design and run (i.e., execute) a business application. The system 10 includes a design-time environment 12 in which a business application may be designed to meet the needs of a particular application. The system 10 also includes a run-time environment 14 in which the business application operates after its design has been completed. Stored information 22 relating to the business application is accessible by both the design-time and run-time environments 12, 14.

To design and execute a business application, information is moved, processed, and stored in the system 10. The design-time environment 12 is connected to a network 16 by connection 18, and the run-time environment 14 is connected to the network 16 by connection 20. The network 16, which may be, for example, an intranet, provides for communications within and between the design-time environment 12 and stored information contained in the repository 22. The network 16 also provides for communication over connection 20 between the run-time environment 14 and the stored information repository 22. The stored information container repository 22 may include knowledge bases, data bases, application programs, and other information accessible by elements of the design environment 12 and the run-time environment 14. A user in the design-time environment 12 may use a computer terminal 22 to enter, modify, and remove information that may include information stored on the stored information repository 22. Similarly, a user in the run-time environment 14 uses a computer terminal 26 to perform run-time applications that can use access, modify, and delete information stored in the stored information repository 22.

In the design-time environment 12, software developers, for example, use various tools, including editors, debuggers and compilers, in order to develop software modules, user interfaces, executable programs, and the like, for use in the run-time environment 14. In developing such run-time environment applications, a user in the design-time environment 14 loads stored information from the stored information repository 22 through the network 16 and into the terminal 24 in order to manipulate that information. For example, the design-time environment 12 user may load application programs from the stored information repository 22 and use those application programs to create, for example, categorization schemes. These created categorization schemes can incorporate business objects and other data-that is also loaded from the stored information repository 22 into terminal 24 in the design-time environment. The user can then store the modified categorization scheme, of this example, back into the stored information repository 22 where it may be accessed from the terminal 26 in the run-time environment 14. Accordingly, the user in the design-time environment 12 can store data and programs in the stored information repository 22 that the user in the run-time environment can use to perform run-time applications. Moreover, the run-time environment user may also manipulate stored information in the stored information repository 22. As such, the run-time environment 14 may affect the data in the stored information repository 22 that is subsequently used within the design-time environment 12.

The enterprise computing system 10 may be connected to additional networks, for example, the Internet. Although not shown in FIG. 1, the Internet may be connected to the design-time environment 12, the run-time environment 14, or the network 16 using standard communication interface hardware and software techniques.

After a business application has been designed in the design-time environment 12, the business application can be executed in the run-time environment 14. Referring to FIGS. 2A-2B, a run-time flow diagram illustrates execution of a business application that uses coherent categorization to perform multiple business process steps. FIGS. 2A-2B illustrate use of coherent categorization schemes in two exemplary versions of the business application, namely a manual categorization, and an automated categorization.

In the manual version shown in FIG. 2A, the business application 28 responds to an input signal 30 by producing an output signal 32. A first business process module 34 executes instructions to perform one of the business application 28 business process steps. To perform that step, the module 34 categorizes the input signal 30. As will be shown with respect to FIG. 5B, a human user manually selects a category displayed on a user interface. The business process module 34 displays categories from a categorization scheme 36, and may limit the displayed categories to those that are relevant to performing the business process step 34. Moreover, because the business application is structured to use the categorization scheme 36, the selected category 38 may be used by a subsequent business process module 40 in the presence of the input signal 30.

Linked to the selected category 38 are linked business objects (BO's) 44. The linked BO's 44 may include information, such as, for example, experts 46, quick solutions 48, and response templates 50. Collectively, these linked BO's 44 may be used in multiple business processes, including business processes 34, 40. Where, for example, the business application is an ERMS, the input 30 may be an incoming e-mail message from a customer. In that case, the business application 28 is used to respond to incoming e-mail messages by providing, for example, a reply e-mail message as the output signal 32.

The categorization scheme 36 is used in a coherent manner because it identifies a selected category 38 that provides relevant BO's 44 to more than one business process module, namely modules 34, 40. As such, the same categorization of an input signal is used to perform more than one business process step. In other words, each business process does not perform its own categorization, as was the case in prior art systems.

A categorization is performed in response to a particular input signal 30, and business processes are performed in reaction to (or in the presence of) a particular input signal. As such, the particular selected category 38 is relevant to a business process only with respect to the content of a particular input signal 30. The selected category may be different for each new incoming input signal. Accordingly, the particular category that is selected within the categorization scheme 36 will depend upon the content of a particular input signal 30.

In the automated version of this example shown in FIG. 2B, a categorization scheme is used to automatically suggest a category, but a user can override that suggestion by manually selecting a different category. For example, the business process module 34 uses the categorization scheme 36 to automatically propose suggested category 39 to subsequently-performed business process module 40. In this example, the business process module 34 may include a content analysis engine for analyzing the content of the input signal 30. In the process of performing the business process module 34, the human user can choose to use the suggested category 39 to perform the business process module 40, or the user can manually select a different category. Whichever category the user selects may be referred to as the selected category 38. This selected category 38 is proposed to the subsequent business process step 42. As such, business process module 42 may use the selected category 38, or the user can override that choice and select a different category.

To promote the efficient performance of the business process modules 40, 42, linked business objects 44 may be filtered to provide only those business objects that are relevant to the business processes 40, 42. A link 51 represents the link from the selected category 38 to the entire set of linked BO's 44. A link 52 provides a subset of the linked BO's 44 to the business process 40. A link 54 provides another subset of the linked BO's 44 to the second business process 42. The business processes 40, 42 can each use the independent subsets of linked BO's 44 provided by respective links 52, 54 to perform their respective business processes within the business application 28.

The links 52, 54 may provide the same subset of linked BO's 44 to both business processes 40, 42. On the other hand, the links 52, 54 may provide subsets of linked BO's 44 that are different. In the latter case, each of the links 52, 54 may be configured to provide BO's that are of a certain type. For example, if the business process 40 is performed to provide a standard e-mail response template, then the link 52 may be configured to provide only BO's that are of the response template 50 type. Similarly, if the business process 42 is performed to select documents for attachment to a reply e-mail, then the link 54 may be configured to provide only BO's that are of the quick solutions 48 type, or of the experts 46 type.

Just as business objects are characterized by their type, each link between a category and a business object is characterized by a type. For example, a link from a category to a document of quick solution 48 type may be characterized as being of “is_solution” type. Similarly, links from categories to experts 46 and to response templates 50 may be characterized as being of “is_expert” and “is response_template” types, respectively.

The use of filtering may be illustrated, at least in part, in the context of an exemplary process of responding to an incoming email request that relates to printers. Initially, business process module 34 performs a content analysis of the input signal 30, and it identifies the key word “printer” in the email. The categorization scheme has a category that corresponds to “printer,” so that category becomes the suggested category 39. When the business process module 40 is performed, the suggested category 39 may be displayed to the user as a proposed category. If the user determines that the email relates specifically to “laser printers,” the user can override the suggested category by manually selecting a “laser printers” category that is a child of the “printers” category. Accordingly, the “laser printers” category becomes the selected category 38. Having selected a category, business objects linked to the “laser printers” category may be provided to the business process module 40 by the link 52. If, for example, the link 52 is configured to filter out business objects that are not of the response template 50 type, then only response templates 50 that are linked to the “laser printers” category are used.

As will be shown in detail below, one exemplary run-time implementation of the coherent categorization scheme automatically displays only those business objects that are in the set of linked BO's 44 associated with the selected category 38. In the exemplary business application 28, BO's 44 that are not relevant to the business process being performed are, at least initially, filtered out. As such, they are not automatically provided to the business process. Instead, only those BO's most likely to be used are initially displayed to the user. Nevertheless, the user can choose to display business objects that are not linked to the selected category, if that is desired.

By initially displaying only the linked BO's 44, and by filtering out linked BO's that are not of the most relevant type to a business process, a categorization scheme reduces the time and effort the agent must spend performing a business process step. As such, the agent can realize productivity and efficiency improvements. If the categorization is also coherent, a single categorization can serve more than one business process step. By reducing the number of categorizations required to perform a number of business process steps, a coherently categorized system further reduces or eliminates unnecessary time and effort the agent must spend to perform multiple business process steps. As such, coherently categorized systems can yield further efficiency and productivity gains over systems that are not coherently categorized.

The selection of categories to perform the foregoing exemplary business process steps depends on the structural details of the categorization scheme itself. The structures of two exemplary categorization schemes that may be used in the business application 28 of FIGS. 2A-2B are illustrated in FIGS. 3-4. In general, FIGS. 3-4 illustrate how categorization schemes can be used to relate business process steps to relevant business objects, as well as how categorization schemes define relationships between categories.

Referring to FIG. 3, a set of business process steps 100 may be performed, either automatically or in response to user input, during the run-time execution of a business application. The steps in the set of business process steps 100 are linked to a set of categorization schemes 105. Each categorization scheme in the set of categorization schemes 105 is linked, directly or indirectly, to multiple categories 110. The categories may be distributed across any number of levels. For example, the categories may be arranged in a hierarchical structure having several levels, or they may be arranged in a flat structure in a single level. In hierarchically structured categories, each category below a top level is linked to one parent in the next higher level, and may be linked to any number of child categories in the next lower level. Parent/child categories may also be referred to as categories/sub-categories. Any of the categories 110 may be linked to one or more business objects 115.

Accordingly, the categorization schemes 105 relate business objects 115 to the business process steps 100. By defining these associations, categorization schemes reflect relationships between business processes and resources (i.e., business objects), especially stored information, in the enterprise computing system 10. Moreover, if a categorization scheme 105 identifies a selected category from among the categories 110 that subsequently provides relevant BO's 115 to more than one business process step 100, then that categorization scheme 105 may be referred to as a “coherent” categorization scheme. In a business application that includes coherent categorization, a single categorization may be used to provide business objects to multiple business application business process steps within the business application. As such, the categorization schemes 105 may reflect relationships across multiple business processes.

For example, FIG. 3 shows an interaction record business process step 120 and an ERMS business process step 125. The interaction record business process step 120 is linked by a link 130 to an interaction reason categorization scheme 135. The ERMS business process step 125 is linked by a link 145 to the interaction reason categorization scheme 135, and it is linked by a link 150 to the product categorization scheme 140. Each of the categorization schemes 125 and 140 are linked to a number of categories. The interaction reason categorization scheme 135 is shown as having a hierarchical structure, while the product categorization scheme 140 is shown as having a flat structure. Under the interaction reason categorization scheme 135, there is a link 155 to a LEGOLAND® category 160, a link 165 to a Lego® club category 170, and a link 175 to a Lego® products category 180. The categories 160, 180 have further sub-categories. The LEGOLAND® category 160 has a link 185 to an entry fee category 190, a link 195 to an events category 200, and a link 205 to a driving directions category 210. Similarly, the Lego® products category 180 has a link 215 to a building instructions category 220. Other links and categories may be added or removed from the interaction reason categorization scheme 135 to provide different responses for the business process steps 120, 125.

By way of example, each of the categories 200, 210 and 220 is linked to relevant business objects within the business objects 115. For example, the events category 200 has a link 225 to a set of business objects 230. As will be described with reference to FIG. 4, the link 225 represents a set of links, whereby each business object in the set of business objects 230 has a uniquely defined link between each business object in the events category 200. Similarly, the driving directions category 210 has a link 235 to a set of business objects 240, and the building instructions category 220 has a link 245 to a set of business objects 250. The sets of business objects 230, 240, 250 each include experts 46, quick solutions 48, and response templates 50.

As has been previously suggested, the sets 230, 240, 250 of business objects are selected from available business objects as being relevant to the categories to which they are linked. As such, the number of business objects of a particular type that are included within the particular set of business objects linked to a category can vary based on the number of business objects that are available. For example, the number of experts that are included in the set of linked business objects 230, 240, 250 depends upon the availability of subject matter experts who have knowledge relevant to the appropriate category. Similarly, the numbers of quick solutions 48 and response templates 50 that are included in a set of linked business objects 230, 240, 250, depend upon the stored contents of, for example, a knowledge base within the stored information repository 22 (FIG. 1).

Accordingly, if the interaction record business step 120 is being performed in the presence of an input signal 30 (not shown), then content of the input signal 30 will determine how the categorization scheme 135 is navigated. If the content of the input signal 30 relates to driving directions to LEGOLAND®, then the categorization scheme would be navigated through the link 155 to the LEGOLAND® category 160, and through the link 205 to the driving directions category 210. If the ERMS business process step 125 is subsequently performed while responding to the same input signal 30, then the business process step 125 will automatically receive business objects that relate to the chosen driving directions category 210 from the set of business objects 240.

Thus, in the foregoing example, the performance of the interaction record business process step 120 categorizes the input signal 30 to select and use the driving directions category 210. The selected category may subsequently be used by a later business process step, in this example, the ERMS process step 125. Accordingly, the exemplary categorization scheme just described exhibits coherency because a selected category identified in one step of a business process can be used to perform a subsequent business process step.

Although the FIG. 3 represents only business objects being linked to categories that exist at a lowest level (children) categories in the hierarchy, business objects may be also be linked to any category that is a parent category. As such, a categorization scheme may be defined such that any category that is selected may be linked to a set of business objects 44.

Additional structural detail of a categorization scheme in accordance with the categorization schemes of FIG. 3 is shown in FIG. 4. In one example, FIG. 4 illustrates the selected category 38 in a magnified portion of a hierarchical categorization scheme 300. The selected category 38 is linked by a link 405 to a parent category (not shown) above it. The selected category 38 is also linked to the linked business objects 44. The selected category may exist at any level in the hierarchical categorization scheme 300. Each of the linked business objects 44 are selected from among all available business objects that are stored, for example, in a database (not shown) in the enterprise computing system 10. The linked business objects 44 may include experts 46, quick solutions 48, and/or response templates 50.

Each of the linked business objects 44 is linked to the selected category 38 by a unique link. Individual experts 46a, 46b, and 46c are linked to the selected category 38 by links 47a, 47b, and 47c, respectively, of the “is_expert” type. Individual quick solutions 48a, 48b are linked to the selected category 38 by links 49a, 49b, respectively, of the “is_solution” type. Individual response templates 50a, 50b, and 50c are linked to the selected category 38 by links 51a, 51b, and 51c, respectively, of the “is_response_template” type. Accordingly, one way to modify the categorization scheme is to modify the links 47, 49, or 51.

Use of the categorization schemes of FIG. 3 in, for example, the manually performed category selection in the business application 28 (FIG. 2A) involves the identification of one or more appropriate categories from within the categorization scheme 36. An exemplary process for manually identifying a selected category 38 is conceptually illustrated in FIG. 5A. An exemplary user interface suitable for manually selecting a category is presented in FIG. 5B.

In the example shown in FIG. 5A (and with reference to FIG. 2B), the contents of the incoming message 30 is analyzed at 520 by, for example, a content analysis engine that searches the message for key words that match queries defined for the categories in the categorization scheme 36. In various embodiments, the key word search can be performed either by a human user, or by a programmed computer. Attributes of a category include properties assigned at design-time, and a category's attributes determine whether a category matches the analyzed content of an incoming message. Content analysis may be performed on the textual content of an unstructured incoming email, for example, by performing query-based categorization, example-based classification (using, e.g., either a nearest neighbor, or a support vector machine algorithm on stored previous examples), a combination of both, or other effective method of content analysis.

The content analysis engine 520 uses a categorization scheme 36 to automatically suggest an initial category 525. This initial category suggestion becomes the current category 530. If a category is found not to have attributes that match the analyzed content, then no category may be initially suggested.

With the current category 530 initially determined, an interactive auto-suggest cycle begins. Business objects 535 that are linked to the current category 530 may be displayed and suggested to the user, thereby allowing the user to quickly access those business objects that are likely to be relevant to the business process step being performed. The user interface, in this example, displays the selected category to the user at 540.

With reference to the user's option to choose a different category 38 than the suggested category 39 in FIG. 2B, the user can iterate as needed by selecting a different current category 530. In turn, the user interface will again display the objects 535 that are linked to the updated current category 530. In this manner, the user can choose to use the business objects that are linked either to the initially suggested category 525, or to a manually selected category.

The foregoing manual selection process can be implemented in a graphical user interface that may be accessed while performing a business process step that involves categorization. An exemplary user interface 550 is illustrated in FIG. 5B. The user interface 550 includes a number of fields that contain drop down list boxes (DDLBs). The user can select a category, for example, from a DDLB 555 labeled “Classification 1.” When selected, the DDLB 555 will display categories that are in a top-level a hierarchical categorization scheme. With reference to FIG. 3, a top-level category would correspond, for example, to categories at the level of the categories 160, 170, 180. The user can then select a category, for example, from a DDLB 560 labeled “Classification 2.” When selected, the DDLB 560 will display categories that are in a level just below those in the DDLB 555. With reference to FIG. 3, these categories would correspond, for example, to categories at the level of the categories 190, 200, 210. The user interface 550 would provide additional levels of categories as needed to permit the user to select any category within the categorization scheme.

The user interface 550 can also provide the functionality that the selection of a category in the DDLB 555 will narrow the displayed alternative categories when the DDLB 560 is selected. This permits the user to quickly work down the categorization scheme from a top level to lower levels without the need to sort through unrelated categories. After the user has selected a category using the user interface 550, the business process that is being performed can use the business objects that are linked to the selected category.

In some circumstances, a run-time user may select any appropriate linked business objects to perform steps in a business process. In other examples, the run-time user may elect not to use any of the linked business objects, opting instead, for example, to use non-linked business objects, or to use no business objects at all. After all steps that require categorization of the incoming message have been performed, then the run-time use of the coherent categorization ends.

In the foregoing example, business objects are linked to a selected category, and the business objects are used to perform a step in responding to the incoming message. The step may be performed once per incoming message, or as many times as the run-time user provides an input command to perform that business process step. As such, user input determines which business process steps are performed in the presence of a particular incoming message. Whether multiple processes are performed or not, the categorization is coherent if multiple business process steps are configured to be able to use business objects linked to a selected category.

One implementation of the business application 28 (FIGS. 2A-2B) is an ERMS as shown in FIG. 6. The ERMS may form part of an enterprise computing system 10 (FIG. 1) to perform business processes other than those performed by the ERMS specific business application. As such, coherent categorization can be used in the enterprise computing system 10 to perform, for example, 1) a step in the ERMS business process, and then 2) a step in a different business process. In this connection, the other business process may be, but is not limited to, recording the interaction, performing service-related procedures, scheduling service orders, processing sales orders (e.g., 1-orders,) data warehousing (e.g., SAP's Business Warehouse), and the like.

In FIG. 6, the result of a coherent categorization is first used by an ERMS business process 600 to respond to an incoming email message 610 by producing a response 612, and then to provide data to a different business process, namely a 1-order repository 632. When the ERMS business process 600 of this example receives the incoming email 610, a content analysis 614 is performed to analyze the contents of the incoming email 610. The analysis may incorporate, for example, a text mining engine (not shown) which provides text to be categorized to a categorization scheme stored in a categorization scheme repository 618. The result of the content analysis step 614 is a suggested category 615.

The suggested category is automatically suggested to a user in a categorization step 616. The categorization step 616 corresponds to the manual selection described with reference to FIG. 2B and FIGS. 5A-5B. Nevertheless, in this manual embodiment, the user can choose whether to accept the suggested category 615, or to choose another category as the selected category 620.

The selected category 620 determines which API 622 is used to display the linked business objects. The API 622 defines, for example, the inheritance rules for displaying business objects. Inheritance rules may optionally be used to cause the display of business objects that are directly and/or indirectly linked to the selected category. For example, the inheritance rules may be configured to cause the display of all objects that are linked to the children of the selected category in addition to the objects directly linked to the selected category. In addition, the inheritance rules may optionally be configured to display business objects linked to parent categories of the selected category. The API 622 is typically configured when the software is installed in the enterprise computing system, and may be modified through maintenance. Accordingly, the API 622 can display business objects linked to parents and/or children of the selected category 620, in addition to the business objects in the set of linked business objects 624 that are directly linked to the selected category 620. The linked business objects 624, which corresponds to the linked business objects 44 in FIG. 2A, include experts 46, quick solutions 48, and/or response templates 50.

The linked business objects 624 represent stored information that is relevant to performing the ERMS business process 600, and specifically to responding to the incoming email 610. For example, the experts 46 may identify a business partner who has special expertise that relates to the content of the incoming email 610. The quick solutions 48 may include documents that address the customer's questions in the email. In addition, the response templates 50 may provide the text of a reply email message so that the agent receives a prepared draft of a reply message.

Using these linked business objects 624, an agent can use an email editor 626 to finalize the response 612. Optionally, the agent may use other viewsets 628 to perform other steps in finalizing the response 612. For example, the agent may use one of the other viewsets 628 to attach a document that is one of the quick solutions 48 in the linked business objects 624. The agent may also involve a subject matter expert in the response 612 by using an expert 46 in the linked business objects 624 to contact the subject matter expert.

In the final step of the ERMS business process 600, the agent ends the contact 630 by, for example, sending the response 612 in the form of an email. Additional processes may be initiated as the contact is ended at 630. In this example, the 1-order repository 632 may record information about the just completed ERMS business process 600 for later uses. In other implementations, information about the transaction may be passed to other business processes within the enterprise system 10 for purposes such as, for example, reporting, monitoring, quality control, and the like.

The just described exemplary ERMS business process 600 may include a number of business process steps that, when performed together, constitute a system for responding to customer emails, and particularly business processes that are capable of supporting a large volume of interactions. Such business processes provide capabilities to interact with customers by e-mail, telephone, mail, facsimile, internet-based chat, or other forms of customer communication. Such business processes may be manual, partially automated, or fully automated. Business processes that include automation generally use computers, which, in some implementations, take the form of enterprise computing systems that integrate and perform multiple business processes.

In this implementation, the content analysis step 614 involves selecting a category based upon the content of the incoming email 610. The content of the email 610 may be first be analyzed by, for example, a text-mining engine. In implementations, the content analysis step 614 may include identifying key words in the header or body, for example, of the incoming email 610. Key words may include words, phrases, symbols, and the like, that are relevant to performing the categorization. With reference to FIG. 3, categorizing the email 610 involves selecting appropriate categories 110 under the appropriate categorization scheme 125 and based on the analyzed content of the e-mail 610.

As will be shown below (in FIGS. 7-9), the computing system displays the business objects that are linked to the selected category 230. This display is customized, as described above, using the categorization scheme objects API 622. The display of the linked business objects 624 allows the user to efficiently identify likely responses to the incoming email 610.

The linked business objects 624 that are displayed can be of at least three types. One type is an expert 46. Experts provide contacts and referrals to human resources who can provide knowledge and support that relates to the selected category 620. Referral of a request in an incoming email 610 to one or more experts 46 may constitute part of preparing the response 612. An expert may be, for example, a business partner (e.g., an independent contractor) who has a business relationship with the enterprise, although not necessarily an employee relationship. A second type of linked business object 624 is a quick solution 48. Quick solutions 48 refer to stored business objects that contain information responsive to the incoming email 610. Quick solutions 48 include documents that directly contain the responsive information, as well as pointers to other sources of such direct information, such as, for example, internet hyperlinks, website addresses, and uniform resource locators (URLs). A third type of a linked business object 624 is a response template 50 that may be incorporated into the email editor 626 for the purpose of providing the agent pre-formatted, predefined content for an email. These response templates save the agent time in drafting the content of a response to each incoming email 610, thereby promoting the efficient performance of the ERMS business process 600. Both quick solutions 48 and response templates 50 may be stored in a knowledge base or other information storage container (e.g., the stored information repository 22 of FIG. 1) that may be accessed during run-time by business processes that use categorization schemes.

In the step of using the email editor 626 to finalize the response 612, the agent can review and edit the email. In addition, the user may also identify and attach to the email information, such as a quick solution 48 (e.g. documents or links to internet-based resources). Although the described implementation refers to preparing a response in the form of a reply email to the customer, other implementations may be used. For example, if an email is prepared, the email may be addressed to the customer who initiated the incoming email 610, or to an expert 46, or to both. However, the response 612 need not be in email form. By way of example, the response 612 may be in the form of a return phone call, facsimile, letter, or other action that may be internal or external to the enterprise system 10. If the incoming email 610 is a purchase order, for example, the response 612 may comprise an internally-generated sales order (via the 1-order repository 632) that ultimately results in the response 612 taking the form of a delivery of goods or services to the customer.

Depending upon the specific business process step that is being performed, the agent could also use the other viewsets 628 to finalize the response 612. The other viewsets 270 may be displayed as a part of a graphical user interface (GUI), as will be shown in FIGS. 7-9. Example viewsets 628 include the following: e-mail editor, interaction log, attachment list, standard response query, value help selection query, standard response detail, knowledge search, search criteria, search results, and cart.

In implementations that are computer-based, portions of the business process steps to prepare the response 612 to the incoming email 610 may be automated. For example, the categorization scheme repository 618 may be stored in a memory location, such as a disk drive, random access memory (RAM), or other equivalent media for storing information in a computer system. In the end contact step at 630, for example, the results at the conclusion of the ERMS business process 600 may be stored in a memory location, such as in a 1-order repository 632, for subsequent use. In the categorization step 616, as a further example, the process of categorizing is automated by using a programmed processor to rapidly execute a series of pre-programmed decisions to navigate a categorization scheme for the purpose of identifying which predetermined categories are most relevant to performing the business process steps of responding to the incoming email 610.

In FIGS. 7-9, a series of screen shots illustrates what an agent sees in the run-time environment 14 when executing the ERMS business process 600 of FIG. 6. In particular, the screen shots show an exemplary run-time graphical user interface (GUI) by which an agent could achieve improved productivity by using coherent categorization to perform various steps in the ERMS business process 600.

In FIG. 7A, categorization of an incoming e-mail is used to automatically suggest e-mail response templates 50. A GUI 700 includes an e-mail editor viewset 710 that includes text 712 from an incoming e-mail message that has already been received. Associated with the e-mail is the sender and recipient e-mail address information in an e-mail header viewset 714. Below the e-mail header viewset is an attachment viewset 716. When a response e-mail is completed and submitted, the contents of the e-mail editor viewset 710, including the original text 712 and any text added by the agent, are e-mailed, along with any attachments identified in the attachment viewset 716, to the recipient in the e-mail header in viewset 714. The GUI 700 further includes an interaction record viewset 718 for monitoring and storing information about the reason for the interaction (see the interaction record business process step 120 of FIG. 3).

In this example, the agent has first entered information into the interaction record viewset 718 based upon the agent's analysis of the text 712 of the incoming message. The agent has specified that the reason for the e-mail relates to directions, that the priority of the interaction is medium, and that the e-mail may be described as relating to directions to LEGOLAND®. As one step of the ERMS business process, the information entered into the interaction record viewset 718 may be stored within the enterprise system 10 for later use.

The information that the agent has entered into the interaction viewset 718 provides the basis for performing a categorization using a categorization scheme. Given the above-entered information, and with reference to FIG. 3, the interaction record business process step 120 initiates a categorization through link 130 of the interaction reason categorization scheme 135. Moreover, because the reason relates to directions, the categorization traverses through the link 155 to the LEGOLAND® category 160, and from there, traverses through the link 205 to the driving directions category 210. Accordingly, the selected driving direction category 210 is linked by the link 235 to the set of linked business objects 240. The linked business objects 240, being linked to the selected category 210, are used to perform the interaction record business process step 120. Because the categorization is coherent, the same linked business objects 240 may be used to perform other subsequent steps in the ERMS business process.

In FIG. 7B, the agent has initiated the step of creating the response email by selecting the drop down list box (DDLB) 730 in the email viewset editor 710. Having previously filtered out all business objects that are not linked to the selected driving directions category 210, the e-mail editor viewset 710 further filters out all business objects that are not response templates 50. A drop-down list box menu 730 displays four response template titles that are in the response templates 50 within the set of linked business objects 240. In this example, the agent can select from the four LEGOLAND® locations, namely Billund, California, Deutschland, and Windsor. According to the text 712 of the incoming message, the agent selects the appropriate response template that provides directions to LEGOLAND® California.

In this example, an analysis of the content of the email has identified that the incoming email request relates to driving directions. In response, the DDLB 730 displays a list of suggested standard responses that are linked to the selected driving directions category 210. The suggested responses include the response templates 50 from the linked set of business objects 240. As such, the suggested responses displayed in the DDLB 730 derive from a categorization based on the text 712 of the incoming email.

In FIG. 7C, the agent has selected an appropriate one of the suggested response templates 50. The text of the selected response template 50 has been automatically entered into the e-mail editor viewset 712. With reference to FIG. 6, all that remains for the agent to do to finalize the ERMS business process 600 is to end the contact 630 and to submit the response 612. This example illustrates how business objects that are linked to a selected category may be used to perform a business process step, namely, the step of inserting an email response template into a response email.

Although, in the foregoing example, the agent selected one of the suggested response templates 50, the agent could have made other choices. For example, the agent could have selected the “More Responses . . . ” from the DDLB 730 to display other business objects that are not linked to the selected driving directions category 210. Alternatively, the agent could have selected more than one of the response templates 50 for inclusion in the reply email.

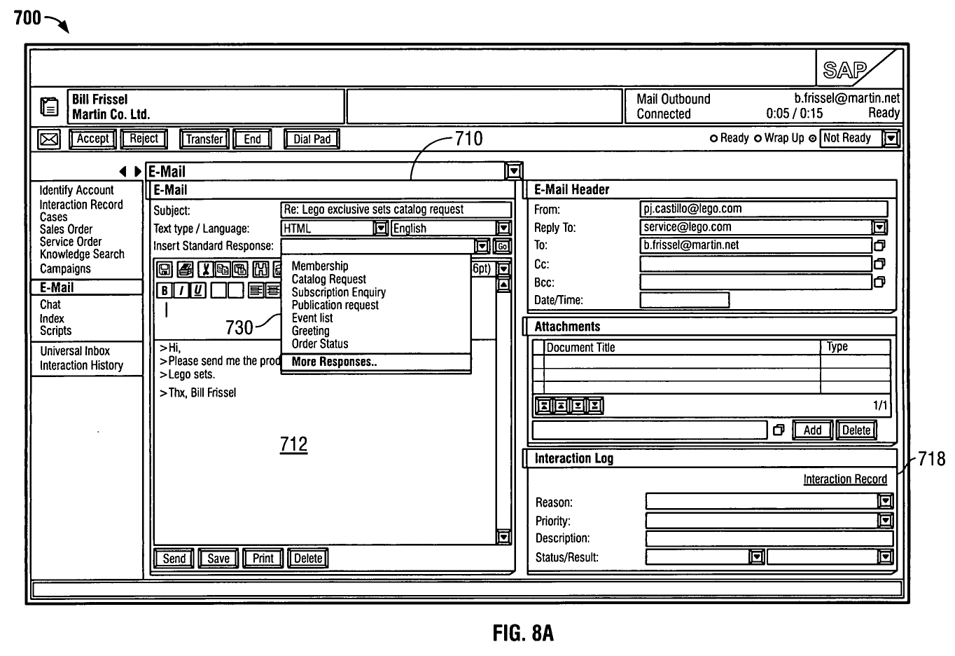

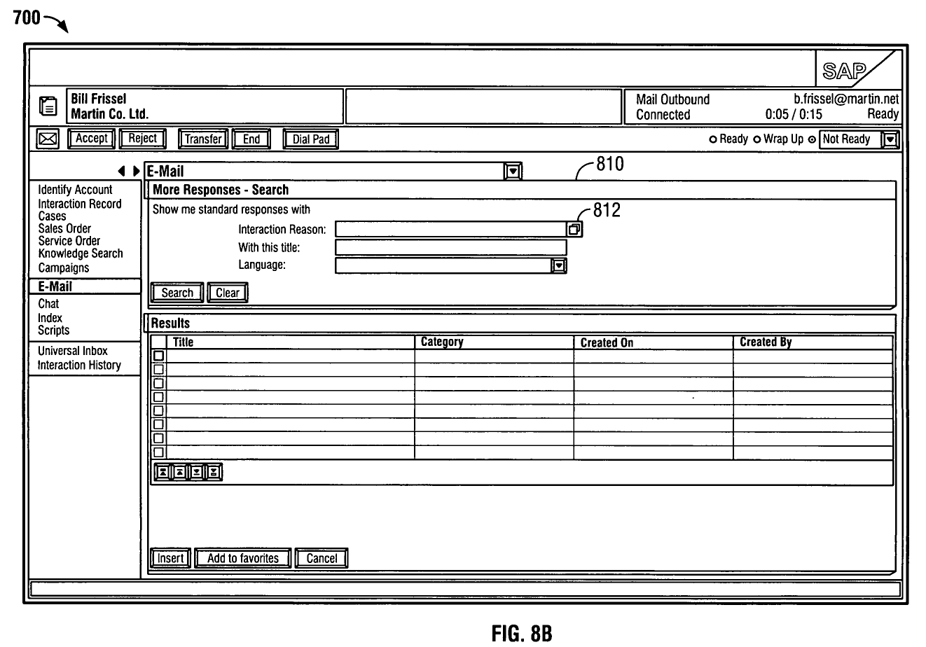

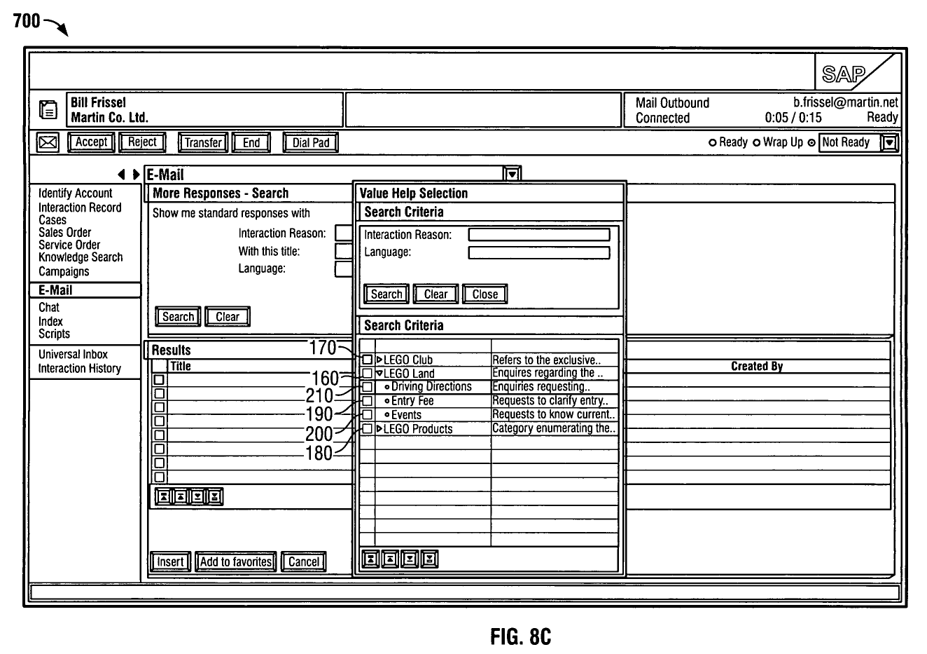

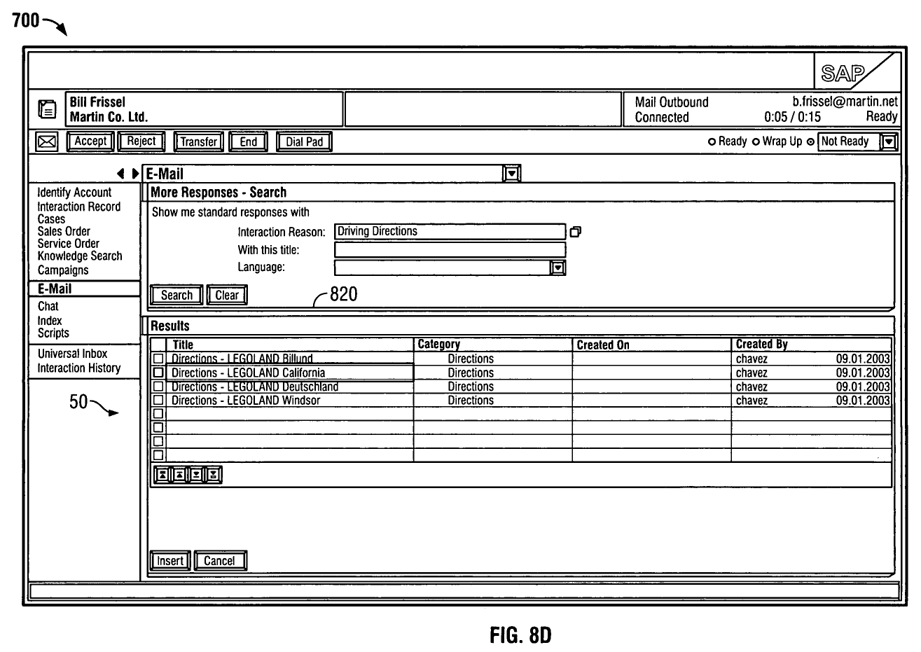

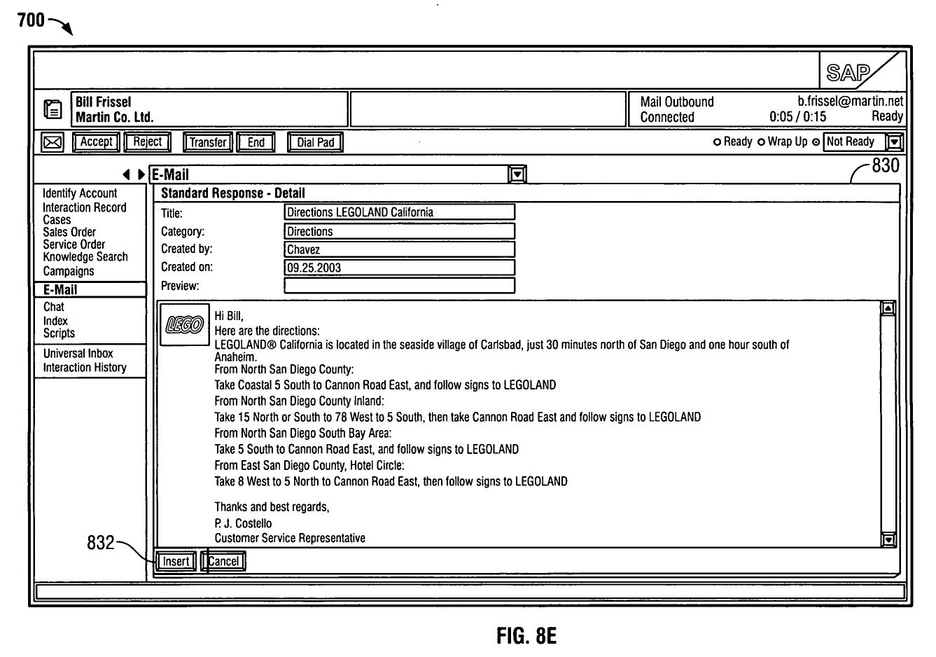

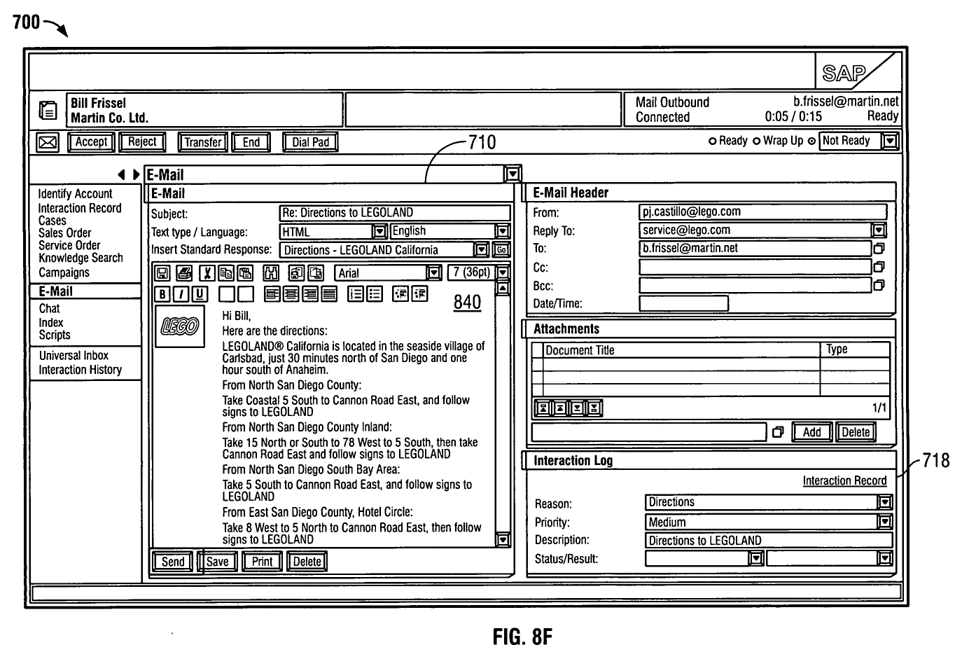

In FIGS. 8A-8F, a standard response template for driving directions to LEGOLAND® in California is processed in a different way than the example illustrated in FIGS. 7A-7C. In FIG. 8A, instead of analyzing the text 712 of the incoming email and then entering information about the e-mail into the interaction record viewset 718, the agent first selects the DDLB 730 to manually select a category by navigating through a hierarchical categorization scheme. In this case, the agent selects the alternative “more responses . . . ” in the DDLB 730 instead of any of the standard responses that are listed by default (not as the result of a categorization) in the DDLB 730.

In FIG. 8B, a “more responses” search viewset 810 is displayed in the GUI 700. Here, the agent selects the interaction reason field 812 to review the details of available interaction reasons. With reference to FIG. 3, the agent will be able to review and select from among available categories within the interaction reason categorization scheme 135.

In FIG. 8C, a number of categories are listed with indications of hierarchical relationships. For example, three categories at a first level within a hierarchy correspond to the categories in FIG. 3 of LEGOLAND® 160, LEGO® CLUB 170, and LEGO® PRODUCTS 180. Under the LEGOLAND® category 160 are displayed the child categories of entry fee 190, events 200, and driving directions 210. Based upon the agent's analysis of the content of the incoming e-mail message, the agent has selected the driving directions category 210.

In FIG. 8D, four response templates 50 linked to the selected driving directions category 210 are displayed in a results viewset 820. Based upon the agent's analysis of the contents of the incoming email, the agent has selected the most appropriate response template 50, namely the directions to LEGOLAND® in California.

In FIG. 8E, the standard response detail viewset 830 displays the selected response template for the agent to review. The agent has selected the “insert” button 832 to insert this response template into the reply e-mail.

In FIG. 8F, the agent can review the reply email in the email editor viewset 710. The reply email 840 now includes both the text 712 of the incoming message and the selected response template 50. Having manually made the categorization selections as described above, the interaction record business process step 120 has been automatically performed using the selected driving directions category 210. In the interaction record viewset 718, the reason and description have been automatically filled-in based upon the categorization.

The ERMS business process step 125 of replying to an e-mail has been performed. The agent has manually categorized the content of the incoming email using the interaction reason categorization scheme 135. After the agent selected the driving direction category 210, a response template 50 linked to that selected category 210 was included in the response. In addition, the selected driving directions category 210 was also used to perform the interaction record business process step 120. Accordingly, the interaction record categorization scheme 135 is coherent in this example because the selected category 210 was used to perform both the ERMS business process step 125 and the interaction record business process step 120.

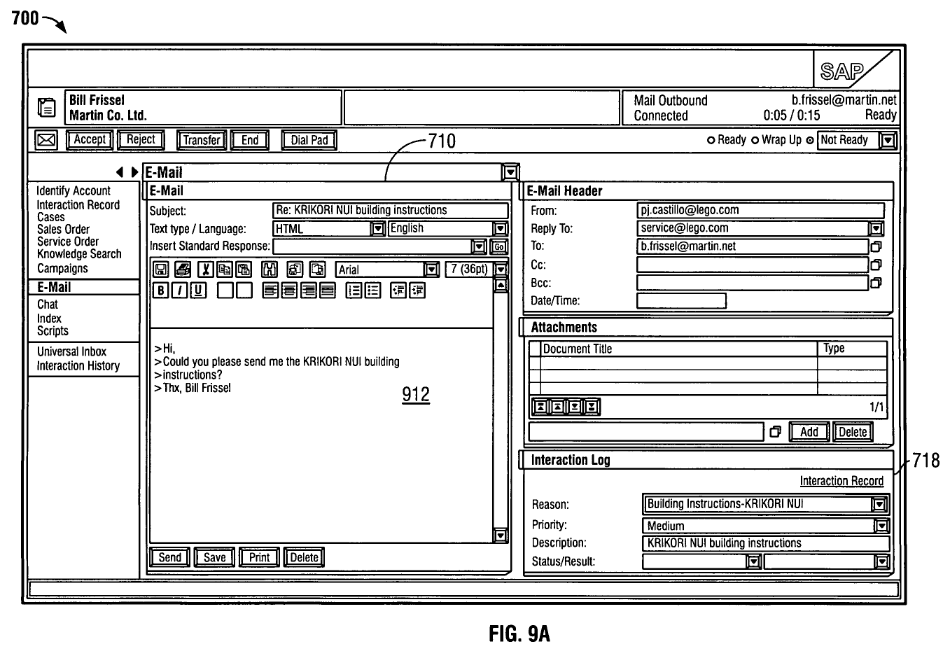

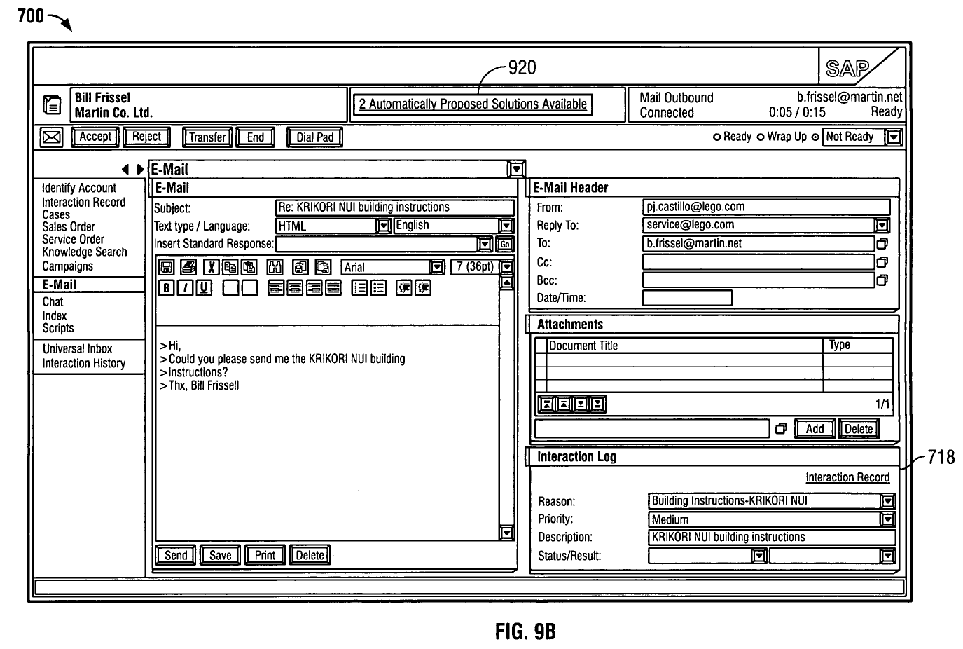

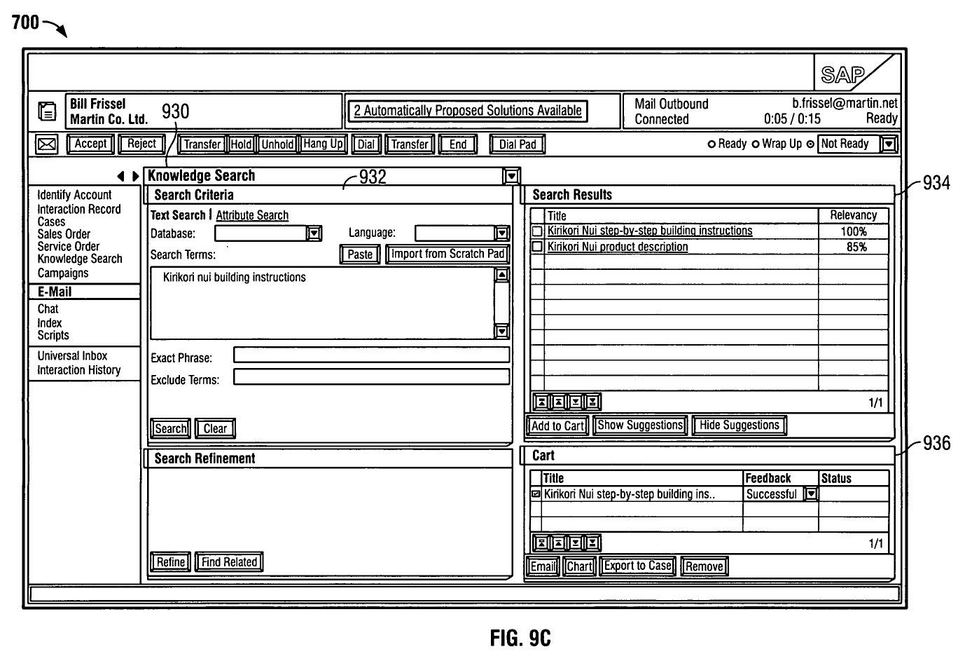

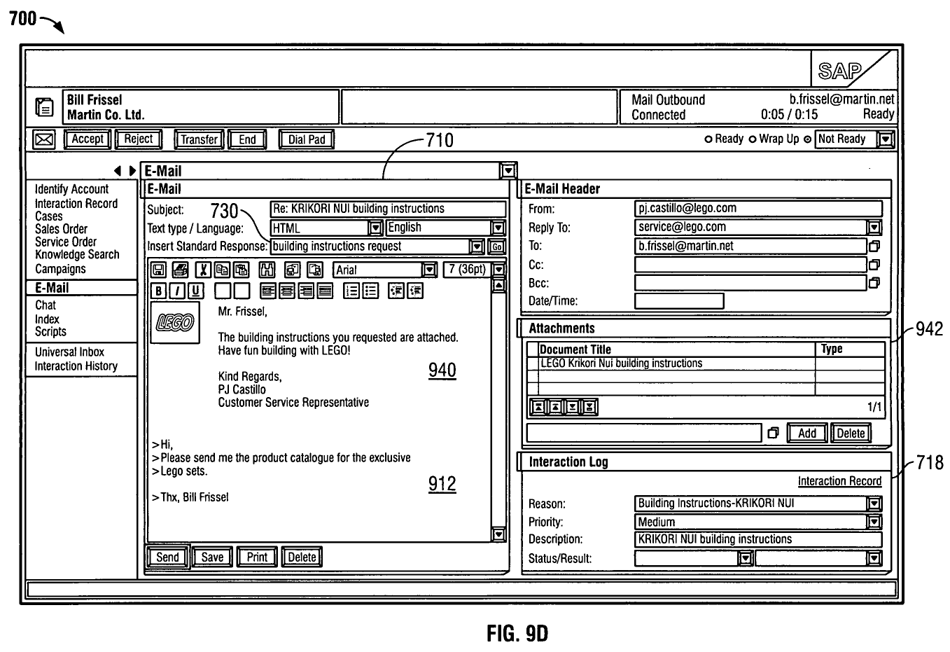

In FIGS. 9A-9D, a coherent categorization scheme is illustrated by an example in which a category selected for the interaction business record process 120 is also used by the ERMS business process 125 to identify both a response template 50 and a quick solution 48.

In FIG. 9A, the agent has entered information about the incoming email message 912 into the interaction record viewset 718. The information entered by the agent is based upon the agent's analysis of the content of the incoming e-mail message 912.

In FIG. 9B, the GUI 700 responds by displaying an alert message 920 to indicate that automatically proposed solutions are available. The alert message 920 indicates to the agent that the information entered into the interaction record viewset 718 has been categorized, and a category having attributes that match the entered information has been selected. Being alerted to this message, the agent looks for the proposed solutions by, for example, selecting a hyperlink associated with the alert message 920.

With reference to FIG. 3, the information entered into the interaction record viewset 718 in this example corresponds to the interaction record business process step 120, the interaction reason categorization scheme 135, the Lego® products category 180 and the building instructions category 220. As such, selecting the alert message 920 leads the agent to a viewset that displays suggested business objects that are in the set of business objects 250, which is linked by the link 245 to the chosen building instructions category 220.

In FIG. 9C, a knowledge search viewset 930 allows the agent to perform free-text searches for business objects in, for example, the stored information repository 22 (FIG. 1). With reference to FIG. 6, the knowledge search viewset arises in the viewsets 628. The knowledge search viewset 930 has a number of sub-viewsets, including a search criteria area 932 for inputting search terms and queries, a search results area 934 for selecting business objects retrieved by the search, and a cart area 936 for displaying selected business objects for later attachment to the reply email. In this example, the reason and the interaction information record information from the interaction record viewset 718 (FIGS. 9A-9B) automatically appear in the search terms dialog box in the search criteria area 932.

In the search results area 934, a list of search results is displayed. In this example, two search results are displayed, each of which corresponds to a quick solution 48 document. With reference to FIG. 3, the proposed quick solutions 48 are in the set of linked business objects 250 because the building instructions category 220 is selected. The displayed titles in the list may be in the form of hyperlinks. In some implementations, selecting a title in the search results area 934 causes the quick solution to be included in the cart area 936. In this example, the agent has selected one of the two quick solution 48 documents in the search results area 934, and the selected document is automatically displayed in the cart area 936.

In FIG. 9D, an attachments viewset 942 includes the quick solutions 48 that were placed in the cart area 936 (FIG. 9C). Not only has the selected quick solution 48, namely, the “Lego® Krikori Nui Building Instructions” document, been included as an attachment to the e-mail, but the DDLB 730 has also been automatically populated with a corresponding response template 50. The agent has selected the suggested response template 50 in the DDLB 730. Accordingly, the text 940 associated with the corresponding response template 50 has been inserted into the e-mail adjacent to the original text 912.

In the foregoing example, two business process steps have been performed using business objects linked to a single selected category. The selected building instructions category 220, which was initially selected during the performance of the interaction record business process step 120, has been used in the ERMS business process to perform the step of attaching a suggested quick solution 48 to the reply e-mail, and to perform the step of inserting a suggested response template 50 into the reply e-mail.

With reference to FIG. 3, the interaction record business process step 120 was performed in response to the agent's entry of content analysis information into the interaction record viewset 718. This triggered a categorization of the entered information using the interaction reason categorization scheme 135. The selected building instructions category 220 is linked to the set of business objects 250. The set of business objects 250 was used to perform two business process steps. First, the quick solutions 48 of the set of linked business objects 250 were used to select a quick solution document to attach to the reply email. Second, the response templates 50 were used in the step of inserting response templates into the reply email. Accordingly, business objects that are linked to a selected category are used to perform multiple business process steps in the presence of an incoming message. As such, the example illustrates how a coherent categorization scheme can be used in the run-time environment 14 to help the agent prepare an e-mail with very little effort and with very little investment of time.

The foregoing examples have illustrated how quick solutions 48 and response templates 50 are types of linked business objects 44 that may be used to perform a business process step. As has been described above, experts 46 are another type of business object that can be linked to a selected category. In an ERMS business process, for example, using an expert 46 involves routing an electronic message to notify and to inform a human expert about the incoming message. Each human expert has the capability to respond to certain categories of incoming messages. The capability of each human expert determines which categories are linked to each expert 46. Because experts that can provide high quality responses are limited resources, and because retaining experts can be costly to an enterprise, the efficient allocation of the time of experts is an important factor in enterprise system cost and quality. Accordingly, the ability to refer only appropriate incoming messages to experts, or routing incoming messages to the appropriate experts, is important.

Routing messages to experts is illustrated in FIG. 10. A computer system 1100 can receive, process and route electronic messages, and it can route incoming messages to human experts. A server device 1102 is operably connected to the Internet 1104, through which it can receive emails and other electronic messages sent from one or more other Internet-connected system(s) 1106. The server device 1102 includes an email program 1108 in which received messages, such as an exemplary incoming electronic message (IEM) 1110, are accessible. The IEM 1110 is currently shown in a general account 1112 that corresponds, for example, to an email address internal to the enterprise. The IEM 1110 will be processed to determine what action(s), if any, to take in response to receiving it. For example, the processing may lead to the IEM 1110 being routed to one or more individual accounts 1114 in the email program 1108. The individual accounts 1114 are assigned to persons working within the enterprise (or organization). For example, each expert can be assigned one of the individual accounts 1114. Accordingly, human experts working within the organization can access their respective individual account 1114 using a client device 1116 that is connected to the server device 1102 through a network 1118. Although only a single IEM 1110 is shown in the general account 1112, in an actual implementations there may be many thousands of messages, or even hundreds of thousands or more. As such, the computer system 1100 can route incoming messages to experts 46 in order to perform various steps in the ERMS business process.

Other Implementations

In implementations, coherent categorization schemes may be used within an enterprise to yield further benefits. For example, when used on-line, the semantics embodied in a categorization scheme can foster a higher level of automation in performing business processes. In addition, when used off-line, an enterprise can analyze a semantic footprint of its daily business by monitoring and reviewing the number of times each category, link, and business object in the categorization scheme is used. This off-line review can provide an enterprise with insight into how it might improve its business processes. Because the categorization in this off-line review is coherent, the semantic expressions represent relationships among business objects and multiple business processes. Thus, coherent categorization may be used both on-line and off-line to improve integration and coordination between business objects and business processes in an enterprise computing system.

In some implementations, a categorization may be coherent where multiple business process steps use business objects linked to more than one selected category. This situation may occur where the analyzed content of an incoming message results in the navigation of a categorization scheme such that more than one category has attributes that match the analyzed content. As such, coherent categorization schemes may be used in implementations in which a number of categories are selected, so long as each selected category has links to business objects that may be used to perform more than one business process associated with the categorization scheme.

In some implementations, business processes may have multiple business processes, and each business process may have multiple steps. A categorization scheme that is associated with multiple business process steps may be associated with business process steps within a single business process, or with steps that span multiple business processes. More than one categorization scheme in an enterprise computing system may be associated with multiple business processes or business process steps. For purposes of being associated with categorization schemes, this document treats business processes and business process steps as being generally interchangeable.

The particular labels used above to describe implementations of the business processes, categorization schemes, and categories and business objects are merely exemplary. Other labels may be used to represent different implementations. For example, the categorization scheme labeled “interaction reason” may have a category labeled “hard disk crash.” In this example, business objects that may be linked to the “hard disk crash” category are, for example, quick solution documents that describe how to recover from a hard disk crash, and e-mail response templates that are used to respond to severe hardware problems.

In implementations, at least some of the categories in a categorization scheme are linked to business objects. In various implementations, business objects may be referred to as knowledge entities, business entities, and the like. As used in this document, these terms generally refer to information contained in an enterprise computing system, and, as such, may be stored using various known techniques for storing information in a computing system. In addition to data and program code, business objects may include links, such as Internet hyperlinks, to information stored outside of, but accessible by, the enterprise computing system. Such information may be stored or transmitted in digital or analog format. Business objects may also include information stored as a computer program product tangibly embodied in an information carrier. As such, the computer program product may contain instructions that, when executed, cause a processor to perform operations according to the implementations described in this document. The information may be stored in an arbitrary location, or in a structured knowledge base, database, information repository, or other equivalent structure for storing information.

With respect to business objects of the type “expert,” the “stored” information may be within the knowledge of a human expert who may be referred to in responding to an incoming message. Typically, an expert has more capability to address certain categories of incoming messages than a general call center agent. “Experts” (also referred to as business partners) may refer to one or more individuals who may be employees or contractors, and who may be on-site or off-site relative to the physical enterprise computing system. Accordingly, references in this document to an expert business object refer to identifying information, such as contact information, stored in the enterprise computing system. As such, a stored expert-type business object may provide a name, phone number, address, email address, website address, hyperlink, or other known methods for communicating with an expert who is linked to a selected category.

Although the examples discussed in this document have focused primarily on business processes that handle inbound and outbound information in the form of email, the coherent categorization schemes may be used with other forms and combinations of inbound and outbound information, including, for example, internet-based chat, data transmitted over a network, voice over telephone, voice over internet protocol (VoIP), facsimile, and communications for the visually and/or hearing-impaired (e.g., TTY), and the like. Furthermore, received information may be in one form while response information may be in a different form, and either may be in a combination of forms. In addition, inbound and outbound information may incorporate data that represents text, graphics, video, audio, and other forms of data. The interaction may or may not be performed in real time.

Furthermore, the use of coherent categorization schemes may have applicability to processes other than the exemplary ERMS business process. For example, coherent categorization can be used to efficiently provide context for responding to anonymous user of e-services. In e-services, users submit requests for information over the Internet at a web-site. In this self-service application, the anonymity of the users means, for example, that the enterprise computing system may not be able to provide context based on past interactions with that user. As such, a coherent categorization can be used to efficiently develop context information and provide suggested solutions to the user.

The invention can be implemented with digital electronic circuitry, or with computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. The essential elements of a computer are a processor for executing instructions and a memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

The invention has been described in terms of particular implementations. Other implementations are within the scope of the following claims.

1. A method of responding to a received message, the method comprising:
analyzing content of a received message to select which of a plurality of predefined categories relates to the received message, each predefined category having response information linked thereto;
if a first of a plurality of predefined computer-executable response modules is executed, executing the first module using at least a first part of the response information linked to the selected category; and
if a second of the plurality of predefined computer-executable response modules is executed, executing the second module using at least a second part of the response information linked to the selected category.

2. The method of claim 1, wherein executing one of the first and second modules involves displaying suggested response message content on a display device, the suggested content being included in the linked response information.

3. The method of claim 2, wherein the suggested content includes at least one document.

4. The method of claim 2, wherein the suggested content includes at least one response template.

5. The method of claim 1, wherein execution further involves receiving user commands to send a response message with the suggested content.

6. The method of claim 5, wherein execution involves executing a message routing instruction that routes the received electronic message to a user's email account, the message routing instruction being included in the linked response information.

7. The method of claim 1, wherein execution involves executing a message routing instruction that routes the received electronic message to a user's incoming electronic message account, the message routing instruction being included in the linked response information.

8. The method of claim 7, wherein the user's incoming electronic message account is that of an expert.

9. The method of claim 1, wherein the first module is one that produces a response message, and the second module is one that executes a procedure other than producing a response message.

10. The method of claim 9, wherein the first part is an auto-response.

11. The method of claim 9, wherein the first part involves suggested content.

12. The method of claim 9, wherein the other procedure is service related.

13. The method of claim 12, wherein the service-related procedure involves scheduling a service order.

14. The method of claim 1 wherein the first and second parts of the linked response information are different.

15. The method of claim 1 wherein the received message comprises an email.

16. A computer program product tangibly embodied in an information carrier, the computer program product containing instructions that, when executed, cause a processor to perform operations to respond to a received electronic message, the operations comprising:
analyze content of a received electronic message to select which of a plurality of predefined categories relates to the received electronic message, each predefined category having response information linked thereto;
if a first of a plurality of predefined computer-executable response modules is executed, execute the first module using at least a first part of the response information linked to the selected category; and
if a second of the plurality of predefined computer-executable response modules is executed, execute the second module using at least a second part of the response information linked to the selected category.

17. A method of performing multiple steps in an Interaction Center (IC) business process, the method comprising:
receiving an email, the content of which relates to one of a plurality of predetermined categories in a categorization scheme, each predetermined category having business objects linked thereto;
selecting a category from among the plurality of predetermined categories;
receiving user input that identifies which of a plurality of response procedure modules are to be executed in response to the received email;
if an email editor module is executed, using a response template selected from among the business objects linked to the selected category; and
if an ERMS module is executed, suggesting at least one business object linked to the selected category, the suggested business object including at least one of a quick solution document and an expert selected from among the business objects linked to the selected category.

18. The method of claim 17, wherein executing one of the first and second modules involves displaying suggested response message content on a display device, the suggested content being included in the linked response information.
